(19) United States
(12) Patent Application Publication
(10) Pub. No.: US 2004/0256826 A1
(43) Pub. Date: Dec. 23, 2004

(54) Arrangement of a pivotable wheel bearing unit

(75) Inventors: Peter Niebling, Bad Kissingen (DE); Jens Heim, Schweinfurt (DE); Heinrich Hofmann, Schweinfurt (DE); Darius Dlugai, Schweinfurt (DE)

Correspondence Address: OSTROLENK FABER GERB & SOFFEN, 1180 AVENUE OF THE AMERICAS, NEW YORK, NY, 100368403

(73) Assignee: FAG Kugelfischer AG

(21) Appl. No.: 10/860,754

(22) Filed: Jun. 3, 2004

(30) Foreign Application Priority Data
Jun. 2, 2003 (DE) 103 25 056.5

(51) Int. Cl. B62D 7/18

(52) U.S. Cl. 280/93.512

(57) ABSTRACT

An auxiliary, power-actuated, pivotable wheel bearing unit is accommodated on a wheel carrier such that it can be pivoted about a pivot axis. An actuating element is attached to the bearing unit at a joint axis to pivot the bearing unit about the pivot axis. The axes are positioned with the pivot axis below the mid-axis of the bearing unit and the joint axis above the mid-axis.

### FIELD OF THE INVENTION

The invention relates to an arrangement of a pivotable wheel bearing unit, the wheel bearing unit being attached in relation to the vehicle such that it can be pivoted about a pivot axis in two mutually opposite directions.

### BACKGROUND OF THE INVENTION

The vehicle wheels, which are normally supported by a wheel mounting on a wheel suspension, can have their camber and/or track adjusted by means of an apparatus, as described in DE 35 09 440 C2. For this purpose, a measured value describing the current driving state of the vehicle is determined on the vehicle, even from its wheel. That value is supplied to a control circuit, is converted into actuating signals and is passed on to an actuating drive. The actuating drive actuates an actuating element which, in turn, pivots the wheel in relation to a vertical plane which is perpendicular to the roadway and aligned in the direction of travel. The wheel can be set to have either a negative camber or a positive camber, for example.

### SUMMARY OF THE INVENTION

It is an object of the invention to provide a wheel bearing unit which can be adjusted by means of such an apparatus, and particularly to provide a suitable attachment of the wheel bearing unit that can be pivoted in relation to the vehicle. The object is to configure the attachment of the wheel bearing unit such that the unit can be employed in existing axle designs of vehicle manufacturers without major changes to the axle design.

This object is achieved by the features described herein. The wheel bearing unit can be pivoted in relation to the vehicle. The bearing unit is attached to a wheel carrier fixed to the vehicle such that the bearing unit can be pivoted about a pivot axis in at least two mutually opposite directions, for example in order to change the camber when the vehicle is at a standstill or is being driven. The pivot axis is spaced at a distance from the mid-axis of the wheel bearing unit, wherein the mid-axis corresponds to the axis of rotation of the vehicle wheel, and the pivot axis extends transversely with respect to the mid-axis. The wheel bearing unit may be pivoted about the pivot axis by an auxiliary power-operated actuating element.

The actuating element is actuated, for example, by a linear or rotationally acting drive. Drives of this type, for example, may be electric motor-operated recirculating ball screws, electric motor-operated racks or hydraulic drives, and they act on the actuating element either directly or through gear mechanisms, for example with force/power multiplication. The actuating element may, for example, be a pressure-thrust rod, which is fixed in an articulated manner to the wheel mounting and is possibly also fixed in an articulated manner to the actuating drive or to the gear mechanism. In this case, the actuating element acts on a joint axis which is imaginary and extends parallel to the pivot axis. The joint axis and the pivot axis lie in a common imaginary pivoting plane and are pivotable about the pivot axis with the wheel mounting. The mid-axis passes through the pivoting plane at a height between the pivot axis and the pivot.

The above described wheel mounting can be pivoted along with the vehicle wheel and relative to the wheel carrier fixed to the vehicle. The wheel mounting is thus supported and fixed to the wheel carrier in an articulated manner such that it can be pivoted about the pivot axis and at one or more attachment points through which the pivot axis passes. Forces on the wheel are passed on to the wheel carrier through this or these attachment point or points. Under certain circumstances, a further support for the wheel is provided at the level of the joint axis, where the actuating element is guided transversely with respect to the standing plane of the wheel.

Other features and advantages of the present invention will become apparent from the following description of the invention which refers to the accompanying drawings.

### BRIEF DESCRIPTION OF THE DRAWINGS

Further configurations of the invention are explained in more detail below using an exemplary embodiment.

FIGS. 1 and 2 show a wheel bearing unit on a wheel carrier.

### DESCRIPTION OF A PREFERRED EMBODIMENT

The wheel bearing unit 1 is supported on a wheel carrier 2. The unit 1 is formed by a hub 3 and an outer body 4 and two rows of cage-guided antifriction elements 5. The hub 3 is rotatably mounted concentrically with respect to the outer body 4 in the outer body 4, which is fixed against rotation in relation to the vehicle. In this case, the hub 3 and the outer body 4 are supported on each other via the antifriction elements.

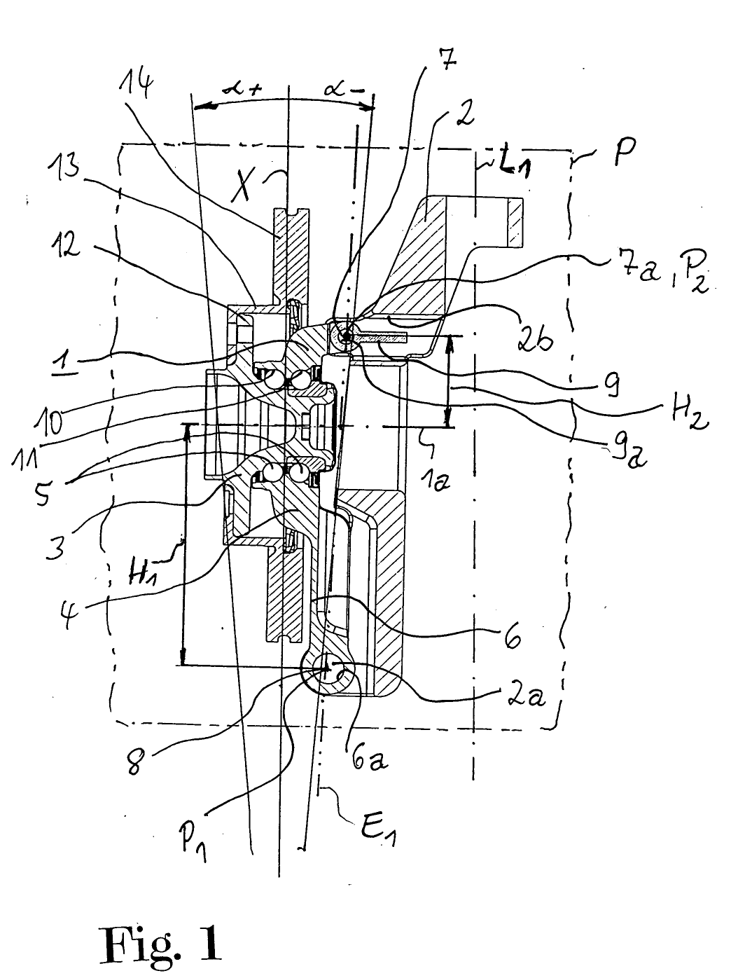

The outer body 4 is provided with at least one lever 6, which protrudes radially from the mid-axis 1a of the wheel bearing unit 1 and on which a pivot eye 6a is formed. The lever 6, as can be seen in FIG. 1, projects from the outer body 4 in the direction of the ground or the roadway on which the vehicle, not illustrated, can be moved. At the side of the mid-axis 1a opposite the pivot eye 6a, a joint 7 is formed on the outer body 4.

The wheel carrier 2 is fixed to the vehicle, not illustrated, such that it can be pivoted about a vertical axis L₁. The carrier 2 has a journal 2a and a guide 2b. The mid-axis of the journal 2a is the pivot axis 8. The lever 6 is seated on the journal 2a with the eye 6a such that it can be pivoted about the journal 2a. As an alternative, the lever 6 has a corresponding journal, which is accommodated such that it can be pivoted in an eye of the carrier.

An actuating element 9 is guided in the guide 2b such that it can move longitudinally, i.e., to left and right in the Figure or transversely of the vehicle. The actuating element 9 in this case has a joint eye 9a at which it can be pivoted about the joint axis 7a.

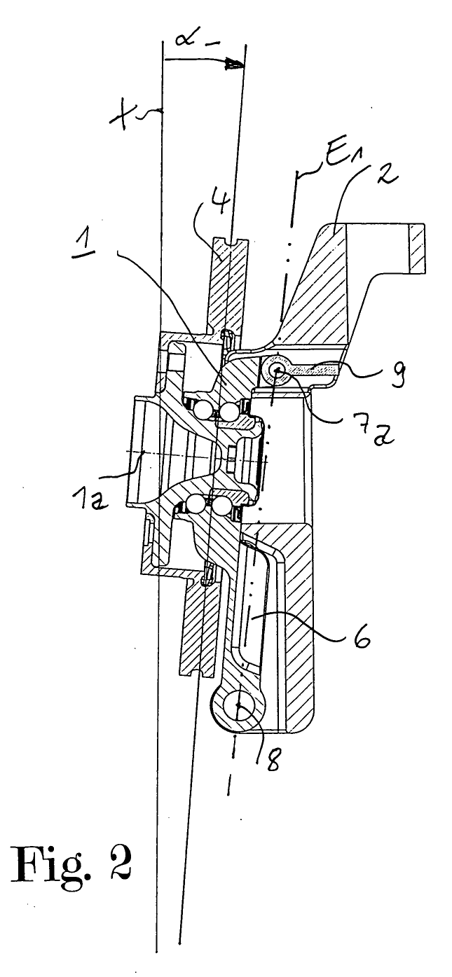

The wheel bearing unit 1 is attached to the wheel carrier 2 such that the bearing unit can be pivoted about the pivot axis 8 in two opposite directions marked by the double arrow. If the wheel bearing unit 1 is inclined by the angle α⁺ outward laterally, the wheel is inclined with positive camber and, if the wheel bearing unit 1 is inclined by the angle α⁻ inward laterally, the wheel is inclined with negative camber. In FIG. 1, the vertical axis X is perpendicular to the roadway. In FIG. 2, the wheel bearing unit 1 is shown inclined such that a negative camber is set on the wheel, not illustrated.

The pivot axis 8 is spaced at a distance from the mid-axis 1a of the wheel bearing unit 1 and the axis 8 runs transversely with respect to the mid-axis 1a. The joint axis 7a and the pivot axis 8 run parallel to each other and are in a common pivoting plane E₁ which is imaginary. That plane E₁ can be pivoted about the pivot axis 8, together with the wheel bearing unit 1. The mid-axis 1a pierces the pivoting plane E₁ between the pivot axis 8 and the joint axis 7a. In this case, the pivot axis 8 in the illustrations according to FIGS. 1 and 2 is located vertically underneath the mid-axis 1a in relation to the vehicle, and the joint axis 7a is located vertically above the mid-axis 1a in relation to the vehicle. This means that the pivot axis 8 is located between the mid-axis 1a and the roadway, and the joint axis 7a runs above the mid-axis 1a between the vehicle, not illustrated, and the wheel bearing unit 1.

The pivot axis 8 passes through a projection plane P (in this case the plane of the Figure) which is oriented in the same direction as the mid-axis 1a. The shortest distance H₁ from the point of passage P₁ of the axis 8 to the mid-axis 1a has a length relationship of at least 2.5:1 with respect to a further shortest distance H₂ between a point P₂ of the joint axis and the mid-axis 1a. At the point P₁, the pivot axis 8 passes through the projection plane P perpendicularly. At the point P₂, the joint axis 7a passes through the projection plane P perpendicularly.

The invention is provided on arrangements with wheel bearing units 1 which are both articulated and unarticulated, and on both driven and non-driven wheels.

In the design of the wheel bearing unit 1 described in FIGS. 1 and 2, the races 10 and 11 for the antifriction elements 5 are formed directly in the outer body 4 and in the hub 3. Wheel bearing units with at least one inner ring and/or at least one outer ring may also be provided. The inner or outer ring(s) in this case has/have the running tracks for balls or tapered rollers and is/are seated in the outer body or on the hub.

It is also conceivable for the hub to have a radial flange or the like, by which the wheel bearing unit is pivotably accommodated on the wheel carrier. In this case, the hub is mounted such that it is fixed against rotation in relation to the vehicle, and the outer body with the wheel is rotatably mounted on the hub.

The hub 3 of the wheel bearing unit 1 has a flange 12, which is provided for the fixing of a brake disk pot 13 with a brake disk 14. Alternatively, a wheel and a brake disk are arranged separately from each other on the wheel bearing unit either one on the hub and one on the outer body or both on the outer body and separately from each other. Since the brake disk 14 is pivoted with the outer body 4, further elements of the disk brake arranged directly on the brake disk can also be pivoted with the outer body 4.

Although the present invention has been described in relation to a particular embodiment thereof, many other variations and modifications and other uses will become apparent to those skilled in the art. It is preferred, therefore, that the present invention be limited not by the specific disclosure herein, but only by the appended claims.

What is claimed is:

1. An arrangement for attaching a pivotable wheel bearing unit to a wheel carrier, the arrangement comprising
the bearing unit being pivotable with respect to the wheel carrier in two mutually opposite directions about a pivot axis; the bearing unit having a mid-axis; the pivot axis being spaced at a distance from the mid-axis of the wheel bearing unit and running transversely with respect to the mid-axis; the wheel bearing unit being pivotable about the pivot axis;
an auxiliary, power-operated, actuating element acting on the bearing unit to pivot the bearing unit about the pivot axis; the actuating element being attached to the bearing unit at a joint axis; at the same time, the actuating element acts in an articulated manner on the joint axis of the actuating element;
the joint axis is parallel to the pivot axis; the joint axis and the pivot axis are located in a common pivoting place which is imaginary, and the plane and the axes can be pivoted about the pivot axis with the wheel bearing unit while at the same time, the mid-axis passes through the common pivoting plane at a location between the pivot axis and the joint axis.

2. The wheel bearing unit of claim 1, wherein the pivot axis runs underneath the mid-axis in relation to the vehicle, and the joint axis runs above the mid-axis in relation to the vehicle.

3. The wheel bearing unit of claim 2, wherein there is a ratio of a first shortest distance between the mid-axis and a first point of passage of the pivot axis, to a further shortest distance between the mid-axis and a second point of passage of the joint axis, which ratio is at least 2.5:1, wherein the pivot axis at the first point of passage passes through an imaginary projection plane oriented in the same direction as the mid-axis, and the joint axis passes through the projection plane at the second point of passage.
